(19) United States
(12) Patent Application Publication
(10) Pub. No.: US 2010/0150610 A1
(43) Pub. Date: Jun. 17, 2010

(54) ELECTROPHOTOGRAPHIC PHOTORECEPTOR AND IMAGE FORMING APPARATUS

(75) Inventors: Seisuke MAEDA, Tokyo (JP); Hirofumi HAYATA, Tokyo (JP); Takeshi ISHIDA, Tokyo (JP); Masahiko KURACHI, Tokyo (JP); Toshiyuki FUJITA, Tokyo (JP); Seijiro TAKAHASHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/635,377

(22) Filed: Dec. 10, 2009

(30) Foreign Application Priority Data
Dec. 17, 2008 (JP) 2008320734

(51) Int. Cl. G03G 15/00; G03G 5/04

(52) U.S. Cl. 399/159; 430/66

(57) ABSTRACT

Provided is an electrophotographic photoreceptor comprising a conductive support provided thereon, a light sensitive layer and a surface layer in this order, wherein the surface layer is formed by a curing reaction of a composition comprising metal oxide particle of which surface are treated by at least a compound having methacryloyl group; and a peak value Tac at 1610-1640 cm⁻¹ and a peak value Tcb at 1700-1800 cm⁻¹ in an infrared absorption spectra of the surface layer after curing satisfy the following Expression 1; Expression 1: 1.0≦(Tac/Tcb)×100≦20.

This application is based on Japanese Patent Application No. 2008-320734 filed on Dec. 17, 2008 with Japan Patent Office, the entire content of which is hereby incorporated by reference.

### TECHNICAL FIELD

The present invention relates to an electrophotographic photoreceptor and an image forming apparatus by using thereof.

In an electrophotographic photoreceptor (herein after, simply referred to as a photoreceptor), a surface layer (usually same as a protect layer) formed by a polymerizable monomer is used for increasing a mechanical strength or for maintaining adequate elasticity. So as to increase more mechanical strength and to give an electrical conductivity, conductive particles, especially metal oxide particles (filler) are included in a surface layer.

A surface layer of an electrophotographic photoreceptor made by thermoplastics often causes an insufficient transfer under an environment of high temperature and high humidity, or unevenness on half-tone image area by a scratch during prolonged use. In order to solve this problem, photoreceptors having harder surface layers were investigated, however an enough positive effect cannot be obtained.

Then a method was investigated in which metal oxide particles were used on the surface layer of an electrophotographic photoreceptor and followed by polymerization to make three dimensional structures by cross-linking by light or heat (Patent Document 1).

However it was difficult to control a dispersion state of fillers. Fillers were coagulated during polymerization of polymerizable monomer or during drying solvent, and tended to be cured in inhomogeneous dispersion state. In order to solve this problem, a reactive group was introduced on a surface of metal oxide particles, and curing was carried out in the highest dispersion state just after coating. As the result, a surface layer having uniform dispersed metal oxide particles can be obtained.

As to specific example of this solution, there are patents which describe a constitution that a surface layer of an electrophotographic photoreceptor is formed by polymerizing a curable acryl monomer or olygomer having a reactive acryl group or methacryl group, and the metal oxide particles are also surface-treated by a coupling agent having a reactive acryl group or methacryl group (Patent Document 2 and 3).

### BACKGROUND

However, when cross-linking reaction is not occurred at some portion, that portion still causes a problem such as image deletion, and abrasion or scratch from prolonged use and degradation occur from that portion because of week scratch resistivity at that portion. Thus enough performances cannot be obtained still more.

Patent Document 1: Unexamined Japanese patent application publication (hereafter referred to as JP-A) 2000-267324

Patent Document 2: JP-A 11-95473

Patent Document 3: JP-A 11-95474

### SUMMARY

In view of the foregoing, the present invention was achieved.

An object of the present invention is to provide an electrophotographic photoreceptor and an image forming apparatus using thereof, which has highly hard and uniform surface layer, and has resistance such as free from scratch, low abrasion, and prevention from image blur for prolonged use.

As a result of diligent investigations, the object of the present invention has been attained by the following constitutions.

1. An electrophotographic photoreceptor comprising a conductive support provided thereon, a light sensitive layer and a surface layer in this order, wherein the surface layer is formed by a curing reaction of a composition comprising metal oxide particles of which surface are treated by at least a compound having methacryloyl group; and a peak value Tac at 1610-1640 cm⁻¹ and a peak value Tcb at 1700-1800 cm⁻¹ in an infrared absorption spectra of the surface layer after curing satisfy the following Expression 1;

1.0≦(Tac/Tcb)×100≦20. Expression 1

2. The electrophotographic photoreceptor of item 1 or 2, wherein (Tac/Tcb)×100 in Expression 1 further satisfy the following Expression 2;

1.0≦(Tac/Tcb)×100≦10. Expression 2

3. The electrophotographic photoreceptor of item 1 or 2, wherein the metal oxide particle is either a titan oxide or aluminum oxide.
4. The electrophotographic photoreceptor of any one of items 1 to 3, wherein the composition further comprising a curable compound.
5. The electrophotographic photoreceptor of item 4, wherein the curable compound has either an acryloyl group or a methacryloyl group.
6. The electrophotographic photoreceptor of item 1, wherein the compound having the methacryloyl group is a silane compound represented by Formula (1):

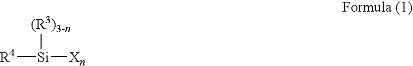

wherein R³ represents a hydrogen atom, an alkyl group having 1-10 carbon atoms and an aralkyl group having 1-10 carbon atoms, R⁴ represents an organic group having a reactive acryloyl group or methacryloyl group, X represents a halogen atom, an alcoxy group, an acyloxy group, an aminoxy group and a phenoxy group, and n represents an integer of 1-3.

7. An image forming apparatus comprising the electrophotographic photoreceptor of any one of items 1 to 6, a charging unit, an image exposing unit, a developing unit and a transfer unit.

According to the invention, the electrophotographic photoreceptor and the image forming apparatus using thereof, which has highly hard and uniform surface layer, and has resistance such as free from scratch, low abrasion, and prevention from image blur for prolonged use can be provided.

### BRIEF DESCRIPTION OF THE DRAWINGS

FIG. 1 is a schematic view showing incorporation, of functions of the image forming apparatus of the present invention.

FIG. 2 is a sectional constitution view of a color image forming apparatus showing an embodiment of the present invention.

FIG. 3 is infrared absorption spectra for showing an evaluation of infrared absorption intensity of the present invention.

### DESCRIPTION OF THE PREFERRED EMBODIMENTS

The present invention will be described in details as below.

The present invention has been achieved by the following constitutions:

an electrophotographic photoreceptor comprising a conductive support provided thereon, a light sensitive layer and a surface layer in this order, wherein the surface layer is formed by a curing reaction of a composition comprising metal oxide particle of which surface are treated by at least a compound having methacryloyl group; and a peak value Tac at 1610-1640 cm⁻¹ and a peak value Tcb at 1700-1800 cm⁻¹ in an infrared absorption spectra of the surface layer after curing satisfy the following Expression 1; more preferably satisfy the following Expression 2;

1.0≦(Tac/Tcb)×100≦20, Expression 1

1.0≦(Tac/Tcb)×100≦10. Expression 2

Further, an electrophotographic photoreceptor and an image forming apparatus using thereof having a surface layer comprising at least metal oxide particles having reactive group and according to necessity comprising a composition obtained by reacting the reactive group and a compound having a polymerizable group forming a chemical bond with the reactive group.

The reason why the present invention has been achieved by above constitutions is considered as follows:

Surface treatment of metal oxide particles may fulfill a role to disperse metal oxide uniformly in a coating compound liquid, to stabilize compound liquid and to hold its dispersing state till drying and curing after coating. Proper viscosity and dispersing power to keep dispersing state of metal oxide particles are needed. A compound having methacryloyl group may properly keep these conditions. In a surface layer after drying and curing, a compound having metacryloyl group may surround metal oxide particles and may not form an extremely hard layer but a layer having proper elasticity. It is important that reactivity may not be extremely high. As a result, reactive points in a surface layer may be uniform and a layer having not so high inner stress can be obtained.

So as to obtain surface layer of photoreceptor which satisfies the conditions above, it is necessary that compound on uniformly dispersed metal oxide particles having metacryloyl group surface-treated fully reacts with each other. It may exhibit above condition that a peak value (Tac) at 1610-1640 cm⁻¹ and a peak value (Tcb) at 1700-1800 cm⁻¹ in an infrared absorption spectra of the surface layer after curing satisfy the following Expression 1:

1.0≦(Tac/Tcb)×100≦20. Expression 1

As described below, so as to satisfy above condition, preferred is to utilize an electron beam as means for curing surface layer.

Tac and Tcb each corresponds to absorption peaks of vibration of C═C bond and C═O bond. Therefore Tac based on Tcb which bond does not change by curing process (namely ratio Tac/Tcb) is considered to exhibit a degree of curing.

By controlling (Tac/Tcb)×100 within the range of Expression 1, curing satisfactorily proceeds and photoreceptor exhibiting high strength, high resistivity to gas attack, and no blurred image can be obtained.

When un-reacted C═C bond is remained, strength of surface layer may be presumed to decrease. Furthermore NOₓ or H₂O tends to absorb at the remaining portion above and causes degradation of surface layer or photosensitive layer at the portion during storage of photoreceptor or during image formation and accelerating degradation of photoreceptor.

[Measurement of Infrared Absorption Spectra]

Infrared absorption spectra can be measured by using, for example, Janssen type Fourier transform infrared micro spectrophotometer by Nippon Bunkou (JASCO Corporation).

As a sample, surface layer (protective layer) of an electrophotographic photoreceptor or a portion corresponding to 3 μm thickness of a scrubbed surface layer from a photoreceptor in the market are measured.

Absorption between wavelength from 4000 cm⁻¹ to 660 cm⁻¹ are measured and a peak value from 1700 cm⁻¹ to 1800 cm⁻¹, and a peak value from 1610 cm⁻¹ to 1640 cm⁻¹ are decided from the spectrum.

The peak value is the value at the highest absorption in the wavelength range above.

The compound, the method for producing surface layer, the constitution of photoreceptor and the method for producing thereof or the image forming apparatus will be described bellow.

[Metal Oxide Particles]

A composition of metal oxide particle of the invention is not limited. Preferable examples are titanium oxide (TiO₂), alumina (Al₂O₃), zinc oxide (ZnO) and tin oxide (SnO), more preferably titanium oxide (TiO₂) and alumina (Al₂O₃).

The preferred average primary particle diameter of metallic oxide of the invention is preferably in the range from 1 nm to 300 nm, more preferably from 3 nm to 100 nm. When the average particle diameter is too smaller than above range, abrasion resistance is not sufficient, and when the average particle diameter is too larger than above range, recording light tend to be scattered or photo-curing tend to be inhibited by particles and results in insufficient abrasion resistance.

The above average primary particle diameter of metallic oxide can be calculated as follows: photographs of particles are taken by scanning electron microscope at 10000-fold magnification. Then the average primary particle diameter of metallic oxide can be calculated by using auto image processing and analyzing apparatus LUZEX AP software Ver.1.32 (product of Nireca Corporation) from these photo images of 300 particles scanned in except for coagulated particles.

A ratio of metal oxide particles in a surface layer is 1 to 200 parts by weight based on 100 parts by weight of a curable compound in a surface layer, preferably 30 to 120 parts by weight.

[Compound Having Methacryloyl Group]

The compound having the methacryloyl group of the invention is a compound which has a reactive methacryloyl group and usable to surface treatment of metal oxide particle without other limitation.

The compound having the methacryloyl group is a compound represented by Formula (1):

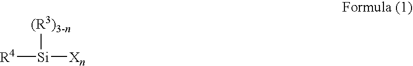

wherein R³ represents a hydrogen atom, an alkyl group having 1-10 carbon atoms and an aralkyl group having 1-10 carbon atoms, R⁴ represents an organic group having a reactive acryloyl group or methacryloyl group, X represents a halogen atom, an alcoxy group, an acyloxy group, an aminoxy group and a phenoxy group, and n represents an integer of 1-3.

Specific examples include silane compounds as below:

S-1 CH₂═C(CH₃)COO(CH₂)₃Si(OCH₃)₃

S-2 CH₂═C(CH₃)COO(CH₂)₃Si(OC₂H₅)₃

S-3 CH₂═C(CH₃)COO(CH₂)Si(OCH₃)₃

S-4 CH₂═C(CH₃)COO(CH₂)Si(OC₂H₅)₃

S-5 CH₂═C(CH₃)COO(CH₂)₃Si(CH₃)(OCH₃)₂

S-6 CH₂═C(CH₃)COO(CH₂)₃Si(CH₃)(OC₂H₅)₂

S-7 CH₂═C(CH₃)COO(CH₂)₂Si(OCH₃)₃

S-8 CH₂═C(CH₃)COO(CH₂)₂Si(CH₃)Cl₂

S-9 CH₂═C(CH₃)COO(CH₂)₂SiCl₃

S-10 CH₂═C(CH₃)COO(CH₂)₃Si(CH₃)Cl₂

S-11 CH₂═C(CH₃)COO(CH₂)₃SiCl₃

S-12 CH₂═C(CH₃)COOSi(OCH₃)₃

S-13 CH₂═C(CH₃)COOSi(OC₂H₅)₃

These silane compounds may be used in single or in mixture of 2 or more.

### [Surface Treatment Method of Metal Oxide Particles by Compound Having Methacryloyl Group]

The metal oxide particles of the present invention treated by compound having methacryloyl group can be obtained by a surface treatment of the metal oxide particles with silane compound such as S-1 to S-13. For this surface treatment, an amount of silane compound as a surface treatment agent is preferably in the range of 0.1-100 parts by weight, amount of solvent is preferably in the range of 50-500 parts by weight based on 100 parts by weight of metal oxide particles; and the surface treatment is carried out by using a wet media dispersing type apparatus.

Specific example of metal oxide particles treated uniform and more finely by a silane compound are described below.

By pulverizing slurry (suspension of solid particles) comprising metal oxide particles and silane compound in wet state, miniaturization of metal oxide particles was carried out simultaneously with surface treatment of metal oxide particles. After eliminating solvent, metal oxide particles treated uniform and more finely by a silane compound can be obtained as powder.

The wet media dispersing type apparatus utilized as the surface treatment apparatus in the invention is an apparatus which has beads in a vessel as a dispersion media, and by rotating a rotating shaft and agitation disk mounted perpendicular on the rotating shaft in high speed, coagulated metal oxide particles are ground and dispersed. Various types of apparatus can be applicable such as vertical type, horizontal type, continuous type and batch type which can disperse and surface treat, when it can fully disperse and treat surface of metal oxide particles. Specifically sand mill, Ultra visco mill, Pearl mill, Grain mill, DINO-mill, Agitator Mill, and Dynamic mill are usable. In these dispersing apparatus, fine grinding and dispersion are carried out via impact crush, friction, shear force, and shear stress by using pulverizing media such as balls and beads.

As beads used in the sand grinder mill, balls made from such as glass, aluminum, zircon, zirconia, steel, and flint are usable. Specifically, zirconia or zircon is preferred. Diameter of beads is generally 1-2 mm, preferably 0.3-1.0 mm in the invention.

As disk and inner wall of vessel used in a wet media dispersing type apparatus, various materials such as stainless, nylon and ceramics are usable. Specifically, disk and inner wall of vessel made of ceramics such as zirconia or silicon carbide is preferred to the invention.

Metal oxide particles having methacryloyl group can be prepared by surface treatment of metal oxide particles with silane compound via above wet processing.

Above metal oxide particles having methacryloyl group preferably may form a surface layer by reacting with compound having polymerizable group of the invention as described below.

[Curable Compound]

The curable compound preferably used in the present invention includes the polymerizable compound which can be cured by reacting with own reactive group. Particularly preferred examples include various compound having carbon═carbon double bond, epoxy compound having cyclic ether structure or oxetane compound.

As above curable compound and compound having methacryloyl group used to surface treatment of metal oxide particles, preferred is a monomer as a resin which is formed by polymerization (curing) by actinic irradiation of an electron beam. Particularly preferred examples of radical polymerizable monomer include styrene monomer, acrylic monomer, methacrylic monomer, vinyl toluene monomer, vinyl acetate monomer, and N-vinyl pyrrolidone monomer. Of these, a particularly preferred example is the photocurable acrylic compound including an acryloyl group or methacryloyl group, because this compound can be cured by a small amount of light or in a shorter period of time.

As for cationic polymerizable monomer, specifically epoxy compound, vinyl ether compound and oxcetane is included. Of these, oxcetane is preferred.

In the present invention, these monomers can be used independently or in a mixed form.

The following shows examples of the curable compound:

The acrylic compound of the present invention is defined as a compound containing the acryloyl group (CH₂ CHCO—) or methacryloyl group (CH₂═CCH₃CO—). The Ac group number (acryloyl group number) to be mentioned in the following description denotes the number of acryloyl or methacryloyl groups.

| Exemplified | | |
|---|---|---|
| compound No. | Structural formula | Ac group number |
| 1 | 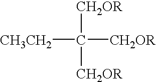 | 3 |
| 2 | 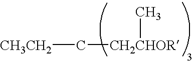 | 3 |
| 3 | 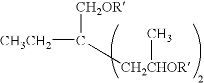 | 3 |
| 4 | 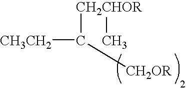 | 3 |
| 5 | 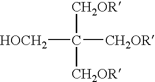 | 3 |
| 6 | 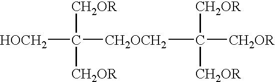 | 4 |
| 7 | 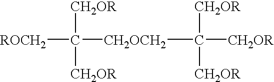 | 6 |
| 8 | 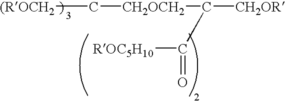 | 6 |
| 9 | 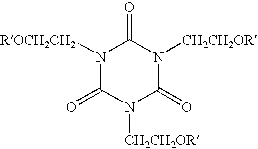 | 3 |
| 10 | 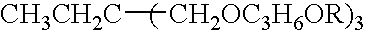 | 3 |
| 11 | 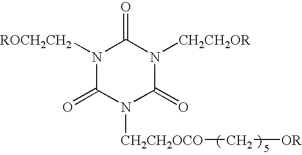 | 3 |
| 12 | 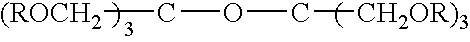 | 6 |
| 13 | 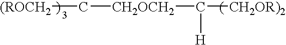 | 5 |
| 14 | 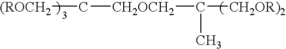 | 5 |
| 15 | 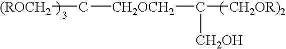 | 5 |
| 16 | 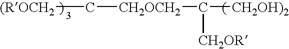 | 4 |
| 17 | 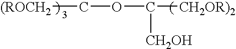 | 5 |
| 18 | 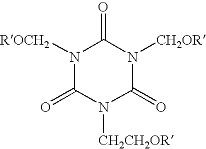 | 3 |
| 19 | 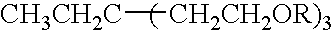 | 3 |
| 20 | 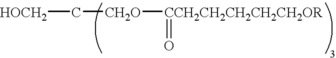 | 3 |
| 21 | 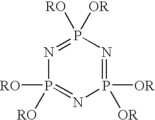 | 6 |
| 22 | 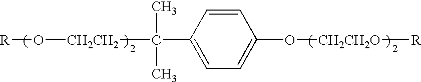 | 2 |
| 23 | 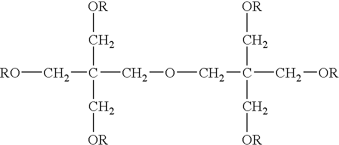 | 6 |
| 24 | 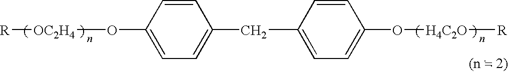 | 2 |
| 25 | 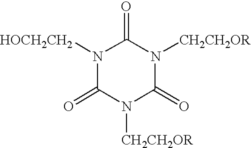 | 2 |
| 26 | 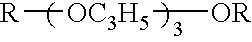 | 2 |
| 27 | 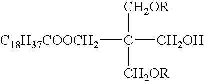 | 2 |
| 28 | 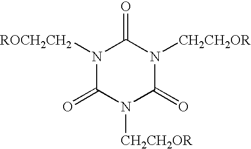 | 3 |
| 29 | 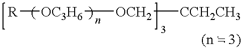 | 3 |
| 30 | 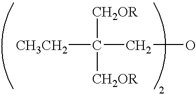 | 4 |
| 31 | 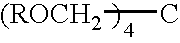 | 4 |
| 32 | RO—C₆H₁₂—OR | 2 |
| 33 | 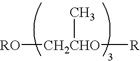 | 2 |
| 34 | 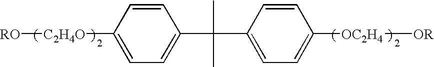 | 2 |
| 35 | 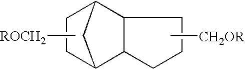 | 2 |
| 36 | 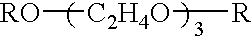 | 2 |
| 37 | 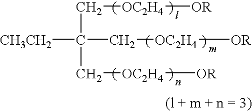 | 3 |
| 38 | 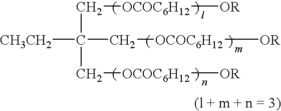 | 3 |
| 39 | 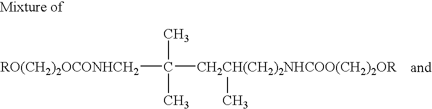 | |
| | 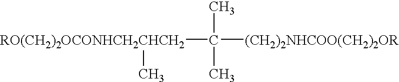 | |
| 40 | (ROCH₂)₃CCH₂OCONH(CH₂)₆NHCOOCH₂C(CH₂OR)₃ | |
| 41 | 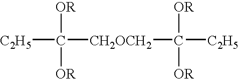 | |
| 42 | 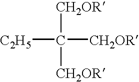 | |
| 43 | 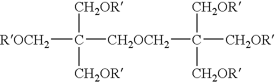 | |
| 44 | 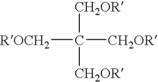 | |

It should be noted that R and R′ in the above description will be shown in the following:

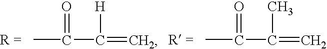

Specific examples of preferable oxcetane compound is described below, but compounds usable in the invention are not limited thereof.

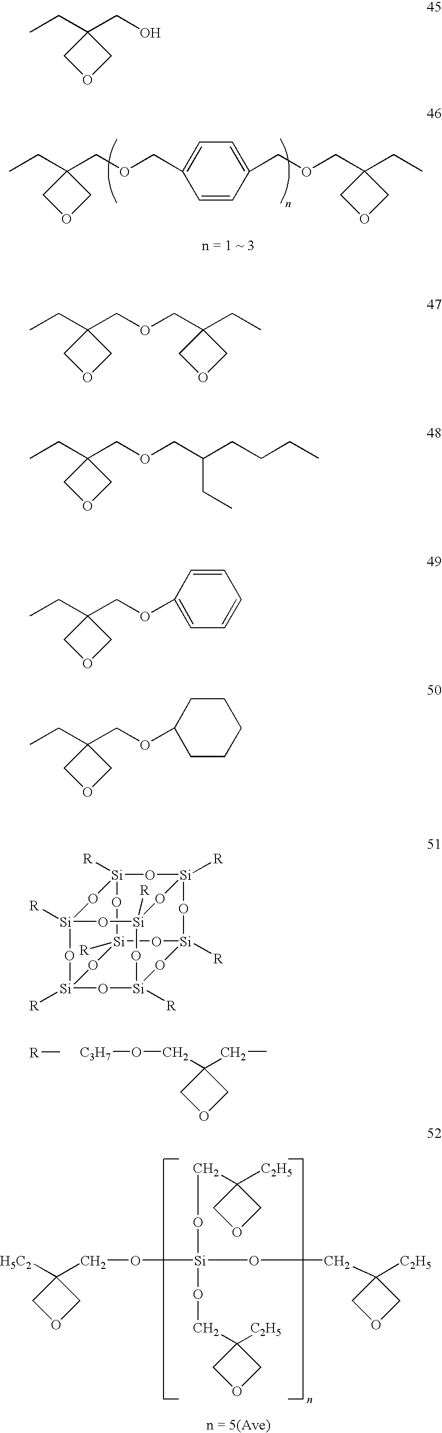

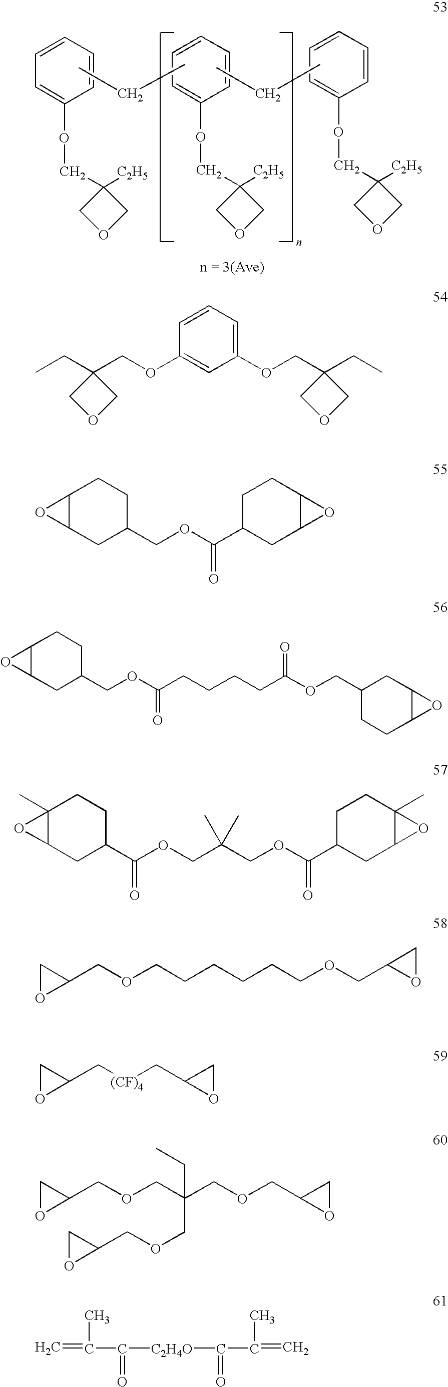

Epoxy compound include aromatic epoxide, alicyclic epoxide and aliphatic epoxide.

In the invention, a number of functional group in curable compound is preferable 2 or more, more preferably 4 or more.

Specifically, methacryloyl group is preferred as functional group.

According to the invention, 2 or more curable compound may be mixed which have different number of functional groups based on molecular weight (density of functional group).

[Additives Other than Above and Others]

The surface layer can be coated with a coating solution formed by mixing a polymerization initiator, filler, lubricant particles, and antioxidant, as required, in addition to the aforementioned curable compound and metal oxide particles, whereby a cured film is formed by the reaction thereof.

The curable compound in the present invention can be put to reaction by electron beam cleavage or by light and heat through addition of a radical polymerization initiator. Either the polymerization initiator or thermal polymerization initiator can be employed. Further, both of these initiators can be used in combination.

So as to form the surface layer of the invention, preferred is the method that coating liquid of surface layer (above composition) is coated on the photosensitive layer, primarily dried to diminish fluidity of coating film, cured the surface layer by irradiating electron beam, and then dried secondarily to control a content of volatile compound in defined amount.

The coating method by an immersion coating in which whole of photoreceptor is immersed in surface layer coating liquid tends to diffuse polymerization initiator or others to a lower layer. The coating method by a circular coating amount controlling coating type coater, typically a circular slide hopper coater, is preferably applied for coating the surface layer since the dissolving of the lower layer can be inhibited as small as possible and the uniform coated layer can be formed by such the coating method. The circular coating amount controlling coater is detailed in, for example, JP-A No. 58-189061.

The surface layer in the present invention can be further provided with various forms of charge transport substances.

Various forms of lubricant particles can be added to the surface layer in the present invention. For example, resin particles containing fluorine atoms can be added. The resin particles containing fluorine atoms are exemplified by ethylene tetrafluoride resin, ethylene trifluoride resin, ethylene hexafluoride propylene resin, vinyl fluoride resin, vinylidene fluoride resin, and ethylene difluoride dichloro resin. It is preferred that, of these copolymers, one or more should be adequately selected and used. Use of the ethylene tetrafluoride resin, and vinylidene fluoride resin is particular preferred. The amount of the lubricant particles in the surface layer is in the range of 5 through 70 parts by mass, preferably in the range of 10 through 60 parts by mass, with respect to 100 parts by mass of the acrylic compound. The preferred particle diameter of the lubricant particles is such that the average primary particle diameter is 0.01 μm through 1 μm. The particularly preferred average primary particle diameter is 0.05 μm through 0.5 μm. There is no particular restriction to the molecular weight of the resin. A proper molecular weight of the resin can be selected.

The solvent for forming the surface layer is exemplified by methanol, ethanol, n-propyl alcohol, isopropyl alcohol, n-butanol, t-butanol, sec-butanol, benzyl alcohol, toluene, xylene, methylene chloride, methyl ethyl ketone, cyclohexane, ethyl acetate, butyl acetate, methyl cellosolve, ethyl cellosolve, tetrahydrofuran, 1-dioxane, 1,3-dioxolane, pyridine, and diethyl amine, without being restricted thereto.

After having been coated, the surface layer of the present invention should be subjected to natural drying or heat drying. After that, the surface layer is preferably made to react by exposure to actinic radiation.

Similarly to the case of the intermediate layer and photosensitive layer, the surface layer can be coated according to such commonly known methods as dip coating, spray coating, spinner coating, bead coating, blade coating, beam coating, and slide hopper coating methods.

For the photoreceptor of the present invention, the following step is preferably used: Actinic radiation is applied to a coating film to generate radicals and cause polymerization. Intermolecular and intramolecular crosslinking is formed by a crosslinking reaction, and curing is performed to generate a cured resin. It is preferred in particular to use electron beam as actinic radiation.

There is no restriction to the electron beam irradiation apparatus as the electron beam source.

Generally, a curtain beam type that produces high power at less costs is effectively used as an electron beam accelerator for emitting the electron beam. The acceleration voltage at the time of electron beam irradiation is preferably in the range of 100 through 300 kV. The absorbed dose is preferably kept in the range of 0.5 through 10 Mrad.

The irradiation time to get the required dose of actinic radiation is preferably in the range of 0.1 sec to 10 min., and is more preferably in the range of 0.1 sec to 5 min.

Electron beam are easy to use as actinic radiation, and are preferably used.

The photoreceptor of the present invention can be dried before and during irradiation with actinic radiation. Appropriate time intervals for drying can be selected by a combination thereof.

Appropriate drying conditions can be selected according to the type of solvent and film thickness. The drying temperature is preferably in the range of the room temperature through 180° C., more preferably in the range of 80° C. through 140° C. Drying time is preferably in the range of 1 min through 200 min, more preferably in the range of 5 min through 100 min.

The film thickness of the surface layer is preferably in the range of 0.2 through 10 μm, more preferably in the range of 0.5 through 6 μm.

[Conductive Support Member]

There is no restriction to the support member used in the present invention if it is conductive. The examples are:

a drum or sheet formed of such a metal as aluminum, copper, chromium, nickel, zinc and stainless steel;

a plastic film laminated with such a metallic film as aluminum and copper;

a plastic film provided with vapor deposition of aluminum, indium oxide, and tin oxide; and

a metal, plastic film, or paper provided with a conductive layer by coating a conductive substance independently or in combination with a binder resin.

[Intermediate Layer]

In the present invention, an intermediate layer having a barrier function and bonding function can be provided between the conductive layer and photosensitive layer.

To form the intermediate layer, such a binder resin as casein, polyvinyl alcohol, nitrocellulose, ethylene-acrylic acid copolymer, polyamide, polyurethane or gelatin is dissolved in the commonly known solvent, and the intermediate layer can be formed by dip coating. Of these materials, alcohol soluble polyamide resin is preferably used.

The solvent used in the intermediate layer is preferably capable of effective dispersion of inorganic particles and dissolution of polyamide resin. To put it more specifically, the preferred solvent characterized by excellent polyamide resin dissolution and coating performances is exemplified by alcohols containing 2 through 4 carbon atoms such as ethanol, n-propyl alcohol, isopropyl alcohol, n-butanol, t-butanol, and sec-butanol. Further, to improve the keeping quality and particle dispersion, it is possible to use an auxiliary solvent providing excellent effects when used in combination with the aforementioned solvent. The examples of such an auxiliary solvent are methanol, benzyl alcohol, toluene, methylene chloride, cyclohexane, and tetrahydrofuran.

The density of the binder resin is selected as appropriate in conformity to the film thickness of the intermediate layer and production speed.

When inorganic particles are dispersed in the binder resin, the amount of the mixed inorganic resin is preferably in the range of 20 through 400 parts by mass, more preferably in the range of 50 through 200 parts by mass, with respect to 100 parts by mass of the binder resin.

An ultrasonic homogenizer, ball mill, sand grinder, and homomixer can be used to disperse the inorganic particles, without being restricted thereto.

The method of drying the intermediate layer can be selected as appropriate in conformity to the type of solvent and film thickness. The method of drying by heat is preferably used.

The film thickness of the intermediate layer is preferably in the range of 0.1 through 15 μm, more preferably in the range of 0.3 through 10 μm.

[Photosensitive Layer]

A laminated type photosensitive layer having an charge generation layer and an charge transport layer is preferably used, without being restricted thereto.

[Charge Generation Layer]

The charge generation layer preferably used in the present invention is the layer that contains the charge generation substance and binder resin, and is formed by dispersing the charge generation substance in the binder resin solution, and coating the same.

The charge generation substance is exemplified by an azo material such as Sudan Red and Diane Blue; quinone pigment such as bilene quinone and anthoanthrone; quinocyanine pigment; perylene pigment; indigo pigment such as indigo, and thioindigo; and phthalocyanine pigment, without being restricted thereto. These charge generation substances can be used independently or in the form dispersed in the commonly known resin.

The conventionally known resin can be used as the binder resin of the charge generation layer. Such a resin is exemplified by polystyrene resin, polyethylene resin, polypropylene resin, acryl resin, methacryl resin, vinyl chloride resin, vinyl acetate resin, polyvinyl butyral resin, epoxy resin, polyurethane resin, phenol resin, polyester resin, alkyd resin, polycarbonate resin, silicone resin, melamine resin, copolymer resin containing two or more of these resins (e.g., vinyl chloride-vinyl acetate copolymer, vinyl chloride-vinyl acetate-anhydrous maleic acid copolymer), and polyvinyl carbazole resin, without being restricted thereto.

The charge generation layer is preferably formed as follows: The charge generation substance is dispersed by a homogenizer into the solution obtained by dissolving binder resin in solvent, whereby a coating solution is prepared. Then the coating solution is coated to a predetermined thickness using a coating device. After that, the coating film is dried, whereby the charge generation layer is formed.

The examples of the solvent used for dissolving the binder resin used in the charge generation layer and coating include toluene, xylene, methylene chloride, 1,2-dichloroethane, methyl ethyl ketone, cyclohexane, ethyl acetate, butyl acetate, methanol, ethanol, propanol, butanol, methyl cellosolve, ethyl cellosolve, tetrahydrazine, 1-dioxane, 1,3-dioxolane, pyridine and diethyl amine, without being restricted thereto.

An ultrasonic homogenizer, ball mill, sand grinder, and homomixer can be used to disperse the charge generation substance, without being restricted thereto.

The amount of the charge generation substance is preferably in the range of 1 through 600 parts by mass of the charge generation substance, more preferably in the range of 50 through 500, with respect to 100 parts by mass of binder resin. The film thickness of the charge generation layer differs according to the characteristics of the charge generation substance and binder resin and percentage of mixture, and is preferably 0.01 through 5 μm, more preferably 0.05 through 3 atm. An image defect can be prevented from occurring by filtering out the foreign substances and coagulants before applying the coating solution for the charge generation layer. It can be formed by vacuum evaporation coating of the aforementioned pigment.

[Charge Transport Layer]

The charge transport layer used in the photosensitive layer of the present invention contains an charge transport substance and binder resin, and is formed by dissolving the charge transport substance in the binder resin and coating the same.

The charge transport substance is exemplified by carbazole derivative, oxazole derivative, oxadiazole derivative, thiazole derivative, thiadizole derivative, triazole derivative, imidazole derivative, imidazolone derivative, imidazolidine derivative, bisimidazolidine derivative, styryl compound, hydrazone compound, pyrazoline compound, oxazolone derivative, benzoimidazole derivative, quinazoline derivative, benzofuran derivative, acridine derivative, phenazine derivative, aminostilbene derivative, triaryl amine derivative, phenylene diamine derivative, stilbene derivative, benzidine derivative, poly-N-vinyl carbazole, poly-1-vinyl pyrene, and poly-9-vinyl anthracene. Two or more of these substances can be mixed for use.

As the charge transportation material (CTM), charge transportation materials having an atomic weight ratio of nitrogen atom being 4.5% or less is preferable. For a fundamental structure of the charge transportation material, triphenylamine derivatives, styryl compounds, benzidine compounds, and butadiene compounds can be used. Of these, styryl compounds are specifically preferable.

The conventionally known resin can be used as the binder resin for the charge transport layer. The examples include polycarbonate resin, polyacrylate resin, polyester resin, polystyrene resin, styrene-acrylnitryl copolymer resin, polymethacrylate ester resin, and styrene-methacrylate ester copolymer. Polycarbonate is preferably used. Further, BRA, BPZ, dimethyl BPA, and BPA-dimethyl BPA copolymers are preferably used because of excellent resistance to cracks and abrasion, and superb antistatic performances.

The charge transport layer is preferably formed by dissolving binder resin and an charge transport substance to prepare a coating solution, which is then applied to the layer to a predetermined thickness. Then the coating film is dried.

The examples of the solvent for dissolving the aforementioned binder resin and charge transport substances include toluene, xylene, methylene chloride, 1,2-dichloroethane, methyl ethyl ketone, cyclohexane, ethyl acetate, butyl acetate, methanol, ethanol, propanol, butanol, tetrahydrofuran, 1,4-dioxane, 1,3-dioxolane, pyridine, and diethyl amine, without being restricted thereto.

The amount of charge transport substance is preferably in the range of 10 through 500 parts by mass of charge transport substance, more preferably in the range of 20 through 100 parts by mass, with respect to 100 parts by mass of binder resin.

The film thickness of the charge transport layer differs according to the characteristics of the charge transport substance and binder resin, and percentage of mixture, and is preferably 5 through 40 μm, more preferably 10 through 30 μm.

An antioxidant, electronic conductive agent, and stabilizer can be applied to the charge transport layer. The antioxidants listed in the Japanese Patent Application No. Hei 11-200135, and electronic conductive agents listed in the Unexamined Japanese Patent Application Publication No. Sho 50-137543 and 58-76483 are preferably used.

[Image Forming Apparatus]

Next, an image forming apparatus employing an organic photoreceptor according to the present invention will now be described.

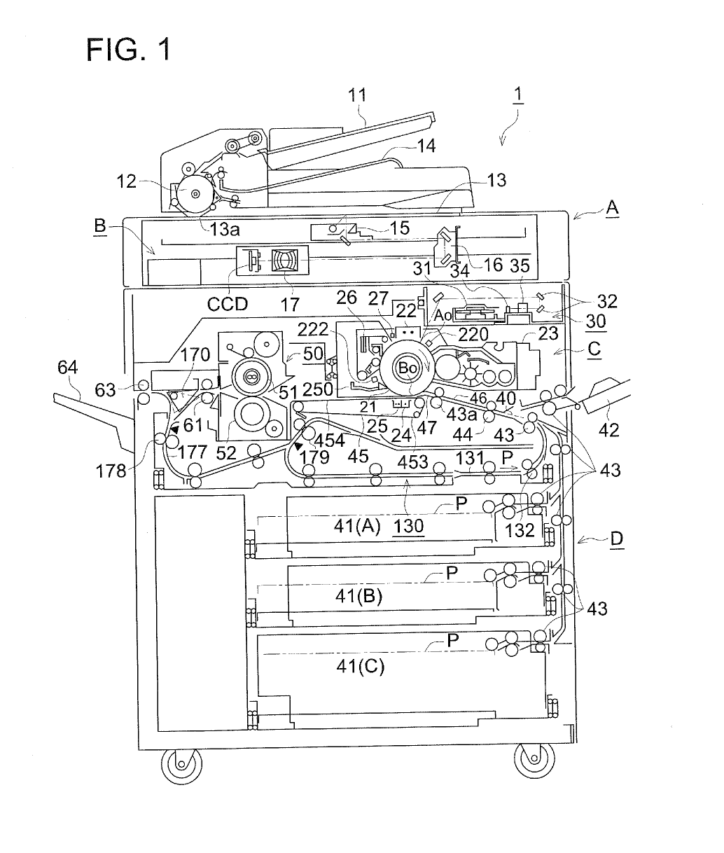

Image forming apparatus 1 shown in FIG. 1 is an image forming apparatus based on a digital mode and composed of image reading section A, image processing section B, image forming section C, and transfer paper conveying section D as a transfer paper conveying member.

An automatic document feeding member to automatically convey an original document is arranged in the upper part of image reading section A. Original documents mounted on document stacking table 11 are conveyed, while being separated sheet by sheet by document conveying roller 12, to carry out image reading at reading position 13a. An original document, having been subjected to document reading, is discharged onto document discharging tray 14.

On the other hand, the image of the original document placed on platen glass 13 is read by reading operation at a rate of v of first mirror unit 15 composed of an illuminating lamp and a first mirror constituting an optical scanning system and by movement at a rate of v/2 in the same direction of second mirror unit 16 composed of a second mirror and a third mirror which are positioned in a V letter.

The read image is focused through projection lens 17 onto the light receiving surface of imaging sensor CCD which is a line sensor. The linear optical image, which has been focused onto the imaging sensor CCD, is successively subjected to photoelectric conversion into electric signals (brightness signals), and then is subjected to A/D conversion. The resulting signals are subjected to various processes such as density conversion and filtering processing in image processing section B, and thereafter, the resulting image data are temporarily stored in a memory.

In image forming section C, there are arranged, as image forming units, drum-shaped photoreceptor 21 which is an image carrier, and on the outer circumference thereof, charging member (charging process) 22 above charging photoreceptor 21, potential detecting member 220 detecting the surface potential of a charged photoreceptor, developing member (developing process) 23, transfer conveyance belt unit 45 as a transferring member (transferring process), cleaning unit 26 (cleaning process) of above photoreceptor 21, and PCL (pre-charge lamp) 27 as a light discharging member (light discharging process) in the order of each movement. Further, reflective density detecting member 222, measuring the reflective density of a patch image developed on photoreceptor 21, is provided on the downstream side of developing member 23. As photoreceptor 21, an organic photoreceptor according to the present invention is used and is rotationally driven clockwise as shown in the drawing.

Rotating photoreceptor 21 is uniformly charged by charging member 22, and image exposure is carried out based on image signals read out by an exposure optical system as image exposure member (image exposure process) 30 from the memory in image processing section B. The exposure optical system as image exposure member 30, which is a writing member, employs a laser diode as a light emitting source, although being not shown in the drawing, and primary scanning is performed by the light pass bent by reflection mirror 32 via rotating polygon mirror 31, fθ lens 34, and cylindrical lens 35, whereby image exposure is performed at the position of Ao against photoreceptor 21 to form an electrostatic latent image via rotation (secondary scanning) of photoreceptor 21. In an example of the embodiments of the present invention, an electrostatic latent image is formed via exposure on the letter portion.

In the image forming apparatus of the present invention, when an electrostatic latent image is formed on a photoreceptor, a semiconductor laser or a light-emitting diode of an oscillation wavelength of 350-500 nm is used as an image exposure light source. Using such an image exposure light source, the exposure dot diameter in the primary scanning direction of writing is narrowed to 10-50 μm, and digital exposure is performed on an organic photoreceptor to obtain an electrophotographic image at an enhanced resolution of 600 dpi (dpi: the number of dots per 2.54 cm)-2500 dpi.

The above exposure dot diameter refers to an exposure beam length (Ld: the maximum length is measured) in the primary scanning direction in an area in which the intensity of the exposure beam is at least 1/e² of the peak intensity.

Light beams used include a scanning optical system employing a semiconductor laser and an LED solid scanner. Light intensity distribution includes Gaussian distribution and Lorentz distribution, and the exposure dot diameter of the present invention is designated for each area having a peak intensity of at least 1/e².

An electrostatic latent image on photoreceptor 21 is reversely developed by developing member 23 to form a toner image, being a visual image, on the surface of photoreceptor 21.

In transfer paper conveying section D, paper feeding units 41(A), 41(B), and 41(C) are arranged as a transfer paper storing member in which sheets of transfer paper P of different size are stored in the lower part of an image forming unit, and manual paper feeding unit 42 is also arranged on the side to manually feed paper. Transfer paper P selected from any thereof is fed along conveying path 40 by guide roller 43. Then, transfer paper P is temporarily stopped by a pair of paper feeding and registration rollers 44 to correct the slant or deviation of fed transfer paper P and then is re-fed, being thereafter guided into conveying path 40, pre-transfer roller 43a, paper feeding path 46, and entering guide plate 47. Then, a toner image on photoreceptor 21 is transferred on transfer paper P while being mounted and conveyed on transfer conveyance belt 454 of transfer conveyance belt unit 45 at transfer position Bo by transfer pole 24 and separation pole 25. Transfer paper P is then separated from the surface of photoreceptor 21 and transferred to fixing member 50 by transfer conveyance belt unit 45.

Fixing member 50 has fixing roller 51 and pressurization roller 52, and fixes toner via heating and pressurization by allowing transfer paper P to pass between fixing roller 51 and pressurization roller 52. Transfer paper P, having been subjected to toner image fixing, is discharged onto paper discharging tray 64.

Image formation on one side of transfer paper has been described above. In the case of duplex copying, paper discharge switching member 170 is switched and transfer paper guide section 177 is opened to convey transfer paper P in the dashed arrow direction.

Further, transfer paper P is conveyed downward by conveying mechanism 178 and switched back by transfer paper turnaround section 179, and then conveyed into the inside of duplex copying paper feeding unit 130 while the end portion of transport paper P is switched to the top portion.

Transfer paper P is shifted toward the paper feeding direction through conveying guide 131 arranged in duplex copying paper feeding unit 130, and then re-fed by paper feeding roller 132 to guide transfer paper P into conveying path 40.

Transfer paper P is conveyed again toward photoreceptor 21 as described above. Then, a toner image is transferred on the rear surface of transfer paper P, fixed by fixing member 50, and then discharged onto paper discharging tray 64.

The image forming apparatus of the present invention may be constituted in such a manner that components such as a photoreceptor, a developing unit, and a cleaning unit described above are combined into a unit as a process cartridge, and then the unit may be structured so as to be fully detachable to the apparatus main body. Further, it is possible to employ the following constitution: a process cartridge is formed holding at least one of a charging unit, an image exposure unit, a developing unit, a transfer or separation unit, and a cleaning unit together with a photoreceptor to form a single unit fully detachable to the apparatus main body in such a manner that the unit is fully detachable using a guide member such as a rail of the apparatus main body.

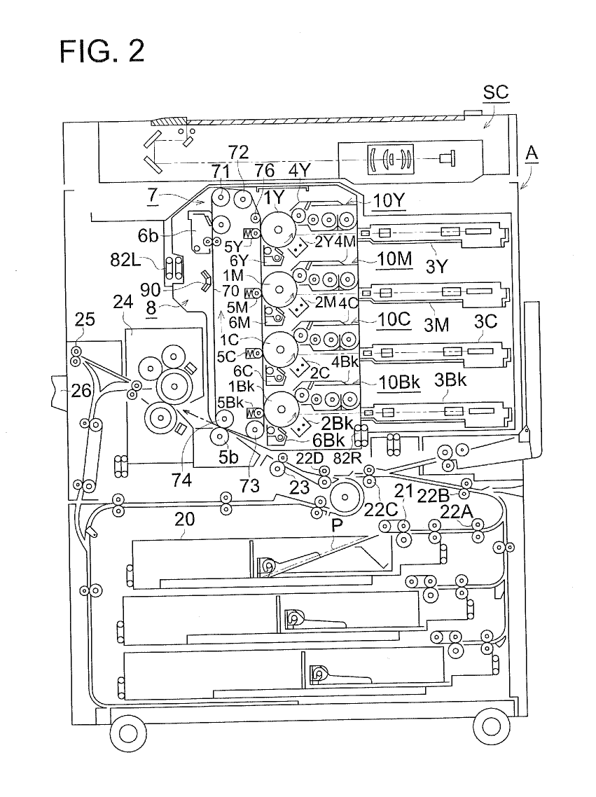

FIG. 2 is a sectional constitution view of a color image forming apparatus showing one embodiment of the present invention.

This color image forming apparatus is referred to as a tandem-type color image forming apparatus, and composed of 4 image forming sections (image forming units) 10Y, 10M, 10C, and 10Bk; endless belt-shaped intermediate transfer body unit 7; paper feeding and conveying member 21; and fixing member 24. In the upper part of image forming apparatus main body A, original document image reading unit SC is arranged.

Image forming section 10Y, forming a yellow image, incorporates charging member (charging process) 2Y arranged around drum-shaped photoreceptor 1Y as a first image carrier, exposure member (exposure process) 3Y, developing member (developing process) 4Y, primary transfer roller 5Y as a primary transfer member (primary transfer process), and cleaning member 6Y. Image forming section 10M, forming a magenta image, incorporates drum-shaped photoreceptor 1M as a first image carrier, charging member 2M, exposure member 3M, developing member 4M, primary transfer roller 5M as a primary transfer member, and cleaning member 6M. Image forming section 10C, forming a cyan image, incorporates drum-shaped photoreceptor 1C as a first image carrier, charging member 2C, exposure member 3C, developing member 4C, primary transfer roller 5C as a primary transfer member, and cleaning member 6C. Image forming section 10Bk, forming a black image, incorporates drum-shaped photoreceptor 1Bk as a first image carrier, charging member 2Bk, exposure member 3Bk, developing member 4Bk, primary transfer roller 5Bk as a primary transfer member, and cleaning member 6Bk.

Above 4 image forming units 10Y, 10M, 10C, and 10Bk are composed, around centrally located photoreceptor drums 1Y, 1M, 1C, and 1Bk, of rotatable charging members 2Y, 2M, 2C, and 2Bk; image exposure member 3Y, 3M, 3C, and 3Bk; rotatable developing members 4Y, 4M, 4C, and 4Bk; and cleaning members 5Y, 5M, 5C, and 5Bk cleaning photoreceptor drums 1Y, 1M, 1C, and 1Bk, respectively.

Image forming units 10Y, 10M, 10C, and 10Bk, described above, each have the same constitution only with different toner image colors formed on photoreceptors 1Y, 1M, 1C, and 1Bk. Accordingly, image forming unit 10Y will now be detailed as an example.

In image forming unit 10Y, around photoreceptor drum 1Y which is an image forming body, there are arranged charging member 2Y (hereinafter referred to simply as charging member 2Y or charging unit 2Y), exposure member 3Y, developing member 4Y, and cleaning member 5Y (hereinafter referred to simply as cleaning member 5Y or cleaning blade 5Y) to form a toner image of yellow (Y) on photoreceptor drum 1Y. Further, in the embodiments of the present invention, with regard to image forming unit 10Y of such a type, at least photoreceptor drum 1Y, charging member 2Y, developing member 4Y, and cleaning member 5Y are provided so as to be unified.

Charging member 2Y is a member to uniformly apply a potential to photoreceptor drum 1Y. In the embodiments of the present invention, corona discharge-type charging unit 2Y is used for photoreceptor drum 1Y.

Image exposure member 3Y is a member to perform exposure onto photoreceptor drum 1Y, having been provided with a uniform potential by charging unit 2Y, based on image signals (yellow) to form an electrostatic latent image corresponding to a yellow image. For such exposure member 3Y, there can be used those composed of an LED, wherein light-emitting elements are array-arranged in the axial direction of photoreceptor drum 1Y, and an imaging element (trade name: SELFOC lens) or Laser optical system.

The image forming apparatus of the present invention may be constituted in such a manner that components such as a photoreceptor, a developing unit, and a cleaning unit described above are combined into a unit as a process cartridge (image forming unit), and then this image forming unit may be structured so as be fully detachable to the apparatus main body. Further, it is possible to employ the following constitution: a process cartridge (image forming unit) is formed holding at least one of a charging unit, an image exposure unit, a developing unit, a transfer or separation unit, and a cleaning unit together with a photoreceptor to form a single image forming unit fully detachable to the apparatus main body in such a manner that the unit is fully detachable using a guide member such as a rail of the apparatus main body. Herein, “holding at least one of a unit” means that a process cartridge can be attachable and detachable as one unit when a process cartridge is attached and detached.

Endless belt-shaped intermediate transfer body unit 7, which is wound around a plurality of rollers, has endless belt-shaped intermediate transfer body 70 as a semiconductive endless belt-shaped second image carrier which is rotatably held.

Each color image formed by image forming units 10Y, 10M, 10C, and 10Bk is successively transferred onto rotating endless belt-shaped intermediate transfer body 70 via primary transfer rollers 5Y, 5M, 5C, and 5Bk as primary transfer members to form a composed color image. Transfer material P as a transfer material (a support to carry the final fixed image, for example, plain paper or a transparent sheet) loaded in paper feeding cassette 20 is fed by paper feeding member 21, and passes through a plurality of intermediate rollers 22A, 22B, 22C, and 22D, and registration roller 23, followed by being conveyed by secondary transfer roller 5b, serving as a secondary transfer member, whereby secondary transfer is carried out onto transfer material P for collective transferring of several color images. Transfer material P, on which color images have been transferred, is subjected to fixing treatment using fixing member 24, and is nipped by paper discharging rollers 25 and deposited on paper discharging tray 26 outside the apparatus. Herein, a transfer support of a toner image formed on a photoreceptor such as an intermediate transfer body or a transfer material collectively refers to a transfer medium.

On the other hand, after color images are transferred onto transfer material P by secondary transfer roller 5b as a secondary transfer member, the residual toner on endless belt-shaped intermediate transfer body 70, which has been curvature-separated from transfer material P, is removed by cleaning member 6b.

During image forming treatment, primary transfer roller 5Bk is always in pressure contact with photoreceptor 1Bk. Other primary transfer rollers 5Y, 5M, and 5C are brought into pressure contact with each of corresponding photoreceptors 1Y, 1M, and 1C only during color image formation.

Secondary transfer roller 5b is brought into pressure contact with endless belt-shaped intermediate transfer body 70, only when transfer material P passes a specified position and secondary transfer is carried out.

Further, chassis 8 is structured so as to be withdrawn from apparatus main body A via supporting rails 82L and 82R.

Chassis 8 is composed of image forming sections 10Y, 10M, 10C, and 10Bk, and endless belt-shaped intermediate transfer body unit 7.

Image forming sections 10Y, 10M, 10C, and 10Bk are tandemly arranged in the perpendicular direction. Endless belt-shaped intermediate transfer body unit 7 is arranged on the left side of photoreceptors 1Y, 1M, 1C, and 1Bk as shown in the drawing. Endless belt-shaped intermediate transfer body unit 7 is composed of rotatable endless belt-shaped intermediate transfer body 70 wound around rollers 71, 72, 73, and 74, primary transfer rollers 5Y, 5M, 5C, and 5Bk, and cleaning member 6b.

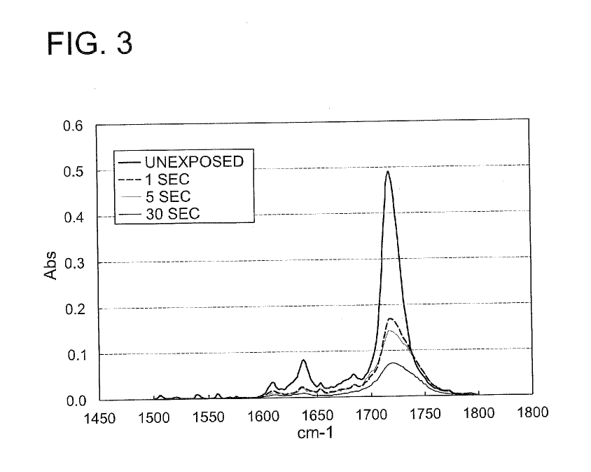

FIG. 3 is a sectional constitution view of a color image forming apparatus (a copier or a laser beam printer having at least a charging member, an exposure member, a plurality of developing members, a transfer member, a cleaning member, and an intermediate transfer body around an organic photoreceptor) employing the organic photoreceptor of the present invention. An elastic material of a medium resistance is used as belt-shaped intermediate transfer body 70.

Numeral 1 is a rotatable drum-type photoreceptor which is repeatedly used as an image forming body and rotationally driven at a specified peripheral rate in the counter-clockwise direction as shown by the arrow.

During rotation, photoreceptor 1 is uniformly charged at a specified polarity and potential by charging member (charging process) 2, and then is subjected to image exposure by image exposure member (image exposure process) 3 (not shown) via scanning exposure light using laser beams modulated in response to chronological electric digital pixel signals of image information to form an electrostatic latent image corresponding to a color component image (color information) of yellow (Y) of the targeted color image.

Subsequently, the resulting electrostatic latent image is developed by yellow (Y) developing member, that is, developing process (yellow developing unit) 4Y using a yellow toner which forms the first color image. During the above operation, each of second-fourth developing members the magenta developing unit, the cyan developing unit, and the black developing unit) 4M, 4C, and 4Bk is not operated and produces no action on photoreceptor 1, whereby the yellow toner image as the first color image is not affected by the second-fourth developing units.

Intermediate transfer body 70 is stretched around rollers 71, 72, 73, and 74, and rotationally driven in the clockwise direction at the same peripheral rate as photoreceptor 1.

While the yellow toner image as the first color, having been formed and carried on photoreceptor 1, passes the nip section of photoreceptor 1 and intermediate transfer body 70, the image is successively subjected to intermediate transfer (primary transfer) onto the outer circumference surface of intermediate transfer body 70 via an electric field formed by primary transfer bias applied to intermediate transfer body 70 from primary transfer roller 5a.

The surface of photoreceptor 1, having completed transfer of the yellow toner image as the first color corresponding to intermediate transfer body 70, is cleaned by cleaning unit 6Y.

Thereafter, in the same manner as above, a magenta toner image as the second color, a cyan toner image as the third color, and a black toner image as the fourth color are successively transferred onto intermediate transfer body 70 in a superposed manner to form a superposed color toner image corresponding to the targeted color image.

Secondary transfer roller 5b is subjected to bearing in parallel to secondary transfer facing roller 74 and is arranged in the bottom surface part of intermediate transfer body 70 so as to be withdrawn.

The primary transfer bias to carry out successive superposing transfer of toner images of the first-fourth colors onto intermediate transfer body 70 from photoreceptor 1 exhibits polarity opposite to that of the toner and is applied from a bias power source. The applied voltage is, for example, in the range of +100 V-+2 kV.

During the primary transfer process of toner images of the first-third colors from photoreceptor 1 to intermediate transfer body 70, secondary transfer roller 5b and intermediate transfer body cleaning member 6b may be withdrawn from intermediate transfer body 70.

Transfer of the superposed color toner image, having been transferred onto belt-shaped intermediate transfer body 70, onto transfer material P as a second image carrier is carried out in such a manner that secondary transfer roller 5b is brought into pressure contact with the belt of intermediate transfer body 70 and transfer material P is fed at specified timing to the contact nip between secondary transfer roller 5b and the belt of intermediate transfer body 70 through a transfer paper guide from paired paper feeding registration rollers 23. Secondary transfer bias is applied to secondary transfer roller 5b from a bias power source. Via this secondary transfer bias, the superposed color toner image is transferred (secondary transfer) onto transfer material. P, which is the second image carrier, from intermediate transfer body 70. Transfer material P, which has been subjected to transfer of the toner image, is conveyed to fixing member 24 and thermally fixed.

[Toner for Developing and Developer]

An electrostatic latent image formed on the organic photoreceptor of the invention is visualized to a toner image by developing. Toner for developing electrostatic image may be a grinded toner and a polymerized toner. A polymerized toner produced by polymerization method is preferably used as the toner of the invention, because of its stable particle diameter distribution.

Polymerized toner is defined as a toner which shape is formed by polymerization of raw material monomer of binder resin and by a chemical treatment after polymerization as appropriate. Specifically polymerized toner includes a toner formed by polymerization such as suspension polymerization and emulsion polymerization and as appropriate by particle fusion process thereafter.

The volume average particle diameter of the toner of the present invention is 2.0-9.0 μm, preferably 3.0-7.0 μm in terms of 50% volume particle diameter described below (Dv50). When the average particle diameter of the toner falls within the above range, high resolution can be obtained. Further by combining small diameter toner within above range, there is decreased the number of fine toner particles, resulting in enhanced dot image quality and enhanced sharpness and stable image in long term.

The toner of the present invention may be used in any of a single-component developer or a two-component develop.

AS for a single-component developer, the toner is used as a single-component non-magnetic developer, or a single-component magnetic developer incorporating a magnetic particles of 0.1-0.5 μm in toner.

As a carrier constituting a two-component developer, usable are magnetic particles composed of conventionally known materials including metals such as iron, ferrite, or magnetite or alloys of the above metals with metals such as aluminum or lead. Specifically ferrite particles are preferably used. The volume average particle diameter of the carrier is preferably 15-100 μm, more preferably 25-80 μm.

It is possible to determine the volume average particle diameter of a carrier, typically, using laser diffraction system particle diameter distribution meter “HELOS” (produced by Sympatec Co.) equipped with a wet type homogenizer.

As the carrier, there is preferably used a carrier further coated with a resin or a so-called resin dispersion type carrier prepared by dispersing magnetic particles in a resin. A resin composition for such coating is not specifically limited. There are used, for example, an olefin based resin, a styrene based resin, a styrene-acrylic based resin, a silicone based resin, an ester based resin, and a fluorine-containing polymer based resin. A resin constituting the resin dispersion type carrier is not also specifically limited, and any of those known in the art may be used, including, for example, a styrene-acrylic based resin, a polyester resin, a fluorine based resin, and a phenol based resin.

The image forming apparatus of the present invention is applied to common electrophotographic apparatuses such as electrophotographic copiers, laser printers, LED printers, or liquid crystal shutter-type printers. In addition, it is possible to find wide applications in display, recording, short-run printing, plate making, and apparatuses such as facsimile machines to which electrophotographic technology is applied.

### EXAMPLES

The present invention will now be detailed with reference to examples, but the embodiments of the present invention are not limited thereto. Incidentally, “part” referred to in the following sentences represents “part by mass.”

Preparation of Photoreceptor 1

Photoreceptor 1 was prepared as follows.

A conductive substrate (machined to the surface roughness Rz=1.5 μm by a cutting operation for cylindrical aluminum substrate) was produced.

<Formation of Intermediate Layer>

An intermediate layer having following composition was formed.

| | | |
|---|---|---|
| Polyamide resin X1010 | 1.0 | part |
| (product of Daicel Degsa) | | |
| Titanium oxide SMT500SAS | 1.1 | parts |
| (product of Teika) | | |
| Ethanol | 20 | parts |

This mixture was dispersed by a sand mill 10 hours in batch.

Above coating solution was coated on the aforementioned substrate by a dip coating method to form an intermediate layer having a dry film thickness of about 2 μm after drying at 110° C., 20 minutes.

<Formation of Charge Generation Layer>

| | | |
|---|---|---|
| Charge generation material: titanyl phthalocyanine | 20 | parts |
| pigment (having a maximum diffraction peak at least | | |
| at a position of Bragg angle 2θ = 27.3° according | | |
| to the Cu—Kα characteristic X-ray diffraction | | |
| spectral analysis) | | |
| Polyvinyl butyral (#6000 by Denki kagaku kougyou) | 10 | parts |
| t-Bytyl acetate | 700 | parts |
| 4-Methoxy-4-methyl-2-pentanone | 300 | parts |

were mixed, and were dispersed using a sand mill for 10 hours to prepare a charge layer coating solution. This coating solution was coated on the intermediate layer according to the dip coating method to produce a charge generation layer having a dry film thickness of 0.3 μm.

<Formation of Charge Transport Layer>

| | | |
|---|---|---|
| Charge transport material: | 150 | parts |
| (compound A described below): | | |
| Binder: Polycarbonate resin | 300 | parts |
| (Z300″ by Mitsubishi Gas Chemical Co. Inc.): | | |
| Anti-oxidant (Irganox1010 by Japan Ciba Geygy): | 6 | parts |
| Toluene/Tetrahydrofuran (volume ratio: 1/9): | 2000 | parts |
| Silicon oil (KF-54 by Shinetsu Chemical) | 1.0 | part |

were mixed and dissolved to produce an charge transport layer coating solution. This coating solution was coated on the charge generation layer according to the dip coating method, and was dried at 110° C. for 60 minutes, whereby an charge transport layer having a dry film thickness of 20 μm was produced.

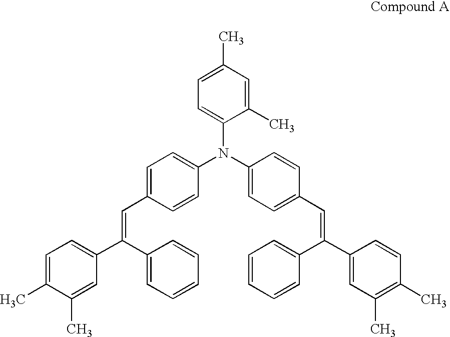

<Formation of Surface Layer>

(Preparation of Metal Oxide Particles Treated by Compound Having Methacryloyl Group)

Into a wet type sand mill with aluminum beads of 0.5 mm diameter, 100 parts by mass of titanium oxide having an average primary particle diameter of 6 nm, 30 parts by mass of “Exemplified compound S-1” as a surface treatment agent, 1000 parts by mass of methylethyl ketone were added and after mixing 6 hours at 30° C. Titanium oxide particles treated by compound having methacryloyl group were obtained by separating methylethyl ketone and aluminum beads by filtration and drying at 60° C.

| | |
|---|---|
| Titanium oxide particles | 100 parts |
| Curable compound | 100 parts |
| (Compound M-1 described in Table 1) | |
| Isopropyl alcohol | 500 parts |

Above components were dispersed 10 hours by using sand mill.

The coating liquid for surface layer was coated on a photoreceptor preliminary prepared to a charge transport layer by using circular slide hopper coater. After coating, the layer was dried for 20 minutes at room temperature (Solvent drying process), irradiated by electron beam while rotating the photoreceptor placed 100 mm away from a electron beam source (Electron beam curing process), and a surface layer with 3 μm thickness was produced.

Preparation of Photoreceptors 2-17 (Preparation of Comparative Photoreceptors)

The photoreceptors 2-17 were produced in the same manner as the photoreceptor 1, except that the material and curing conditions of Table 1 were employed.

Photoreceptor 18 (Metal Oxide Particles Surface Treated by an Unreacted Surface Treatment Agent)

The photoreceptor 18 was prepared in the same manner as the photoreceptor 1, except for changing isobutyl trimethoxy silane as a surface treatment agent for titanium oxide in surface layer from methacryloxy propylmethoxy silane.

Photoreceptor 19 (Metal Oxide Particles Surface Treated by a Reactive Surface Treatment Agent Other than Methacrylate)

The photoreceptor 19 was prepared in the same manner as the photoreceptor 1, except for changing vinyl ethoxy silane as a surface treatment agent for titanium oxide in surface layer from methacryloxy propylmethoxy silane.

Photoreceptor 20 (Titanium Oxide Free, Single Curable Compound)

The photoreceptor 20 was prepared in the same manner as the photoreceptor 1, except for eliminating titanium oxide particles in surface layer.

Photoreceptor 21 (Cured by Using Ultra-Violet Ray)

The photoreceptor 21 was prepared in the same manner as the photoreceptor 1, except for using Ultra-violet ray (500 W, 1 minute) for curing.

[Measurement Method of Infrared Absorption Spectra]

Infrared absorption spectra can be measured by using Janssen type Fourier transform infrared micro spectrophotometer by Nippon Bunkou (JASCO Corporation). As a sample, a portion corresponding to 3 μm thickness of a singularly coated surface layer are measured and normalized by an observed layer thickness measured by eddy current thickness meter. Infrared absorption between wavelength from 4000 cm⁻¹ to 660 cm⁻¹ are measured and peak value from 1700 cm⁻¹ to 1800 cm⁻¹, and peak value from 1610 cm⁻¹ to 1640 cm⁻¹ are decided from the spectrum.

[Evaluation of Photoreceptor]

(Abrasion Resistance of Photoreceptor Surface)

Prepared photoreceptors were evaluated as follows:

Photoreceptor was mounted on bizhub PRO C650 produced by Konica Minolta Business Technologies, Inc. (Tandem color multi function peripheral incorporating laser exposure, reversal development, intermediate transfer body) and modified and improved exposure amount for evaluation. After printing one million papers of A4 image with Y, M, C, Bk color each at 2.5% of printing area ratio on neutralized paper under 20° C., 50% R.H., evaluation of abrasion lines was carried out by observation of a surface state of photoreceptor and a halftone image (0.4 of relative reflection density by Macbeth densitometer). Herein cyan image was used for evaluation of halftone image.

A: After printing one million papers, no abrasion line is noted on the photoreceptor at all and no scratch is noted on the halftone image. (Good)

B: After printing one million papers, small abrasion line is noted on the photoreceptor but no scratch is noted on the halftone image. (Practically non-problematic)

C: After printing one million papers, abrasion line is clearly observed on the photoreceptor and scratch is noted on the halftone image. (Practically problematic)

(Wear Amount of Photoreceptor)

Wear amount of photoreceptor was calculated by measuring a layer thickness of photoreceptor at initial and after printing one million papers according to above evaluation. Ten points of layer thickness were measured in random at uniform thickness portion of photoreceptor and an average was defined as the layer thickness of photoreceptor. At least 3 cm from both edge of photoreceptor were excluded from evaluation, because layer thickness tends to be uneven at edge of photoreceptor. Eddy current type thickness meter EDDY 560C (produced by HELMUT FISHER GMBTE Co.) was used as a layer thickness measuring instrument and the difference between layer thickness of photoreceptor before and after printing was defined as wear amount of photoreceptor.

A: Wear amount of photoreceptor is 1 μm or less. (Good)

B: Wear amount of photoreceptor is 1 μm to 3 μm. (Practically non-problematic)

C: Wear amount of photoreceptor is 3 μm or more. (Practically problematic)

(Blur of Image)

A4 images were printed on neutralized papers to 25 thousand paper prints under the same evaluation conditions except for changing circumstance condition to 30° C., 80% R.H. Main power supply of the printer was cut off 60 second after finishing printing 25 thousand papers. Power was turned on again after standing 12 hours. Just after reaching to printable mode, a halftone image (with 0.4 of relative reflection density by Macbeth densitometer) and 6 dots grid image each were printed on whole of A3 neutralized paper. State of the printed images were observed and ranked according to bellows:

A: No blur is noted on both halftone and grid image. (Good)

B: Slight band density decrease in long direction of photoreceptor is noted only on halftone image. (Practically non-problematic)

C: Defect or thinner line is clearly observed on grid image by blurred image. (Practically problematic)

Evaluation results are listed in Table 1.

TABLE 1

| | | Metal oxide particles | | | | | Curing conditions | | | | | |
|---|---|---|---|---|---|---|---|---|---|---|---|---|
| | Photo- | | Primary | Surface | Curable | | | Radiation | (Tac/ | Evaluation | | |
| | receptor | | diameter | treatment | compound | | Strength | amount | Tcb) × | Abrasion | Wear | |
| | No. | Species | [μm] | agent | Compound | Parts | [KeV] | [Mrad] | 100 | line | amount | Blur |
| Exam- | 1 | ** | 6 | S-1 | M-1 | 100 | 150 | 3 | 9 | A | A | B |
| ple | 2 | Alumina | 100 | S-1 | M-2 | 90 | 100 | 15 | 5 | A | A | B |
| | 3 | ** | 15 | S-3 | M-3 | 200 | 125 | 20 | 12 | B | B | A |
| | 4 | Alumina | 30 | S-2 | M-2 | 60 | 250 | 1 | 5 | A | A | B |
| | 5 | ** | 30 | S-4 | M-1 | 100 | 125 | 5 | 7 | A | A | B |
| | 6 | Alumina | 15 | S-1 | M-5 | 120 | 150 | 30 | 8 | A | B | A |
| | 7 | ** | 6 | S-3 | M-1 | 170 | 200 | 5 | 11 | B | B | A |
| | 8 | ** | 30 | S-3 | M-3 | 100 | 250 | 0.5 | 5 | B | A | A |
| | 9 | Alumina | 30 | S-2 | M-3 | 50 | 200 | 10 | 6 | A | A | B |
| | 10 | Zinc oxide | 10 | S-1 | M-5 | 150 | 150 | 30 | 12 | B | B | B |
| | 11 | Tin oxide | 20 | S-1 | M-1 | 50 | 125 | 10 | 11 | B | B | B |
| | 12 | Zinc oxide | 25 | S-1 | M-2 | 110 | 250 | 0.5 | 15 | B | B | B |
| | 13 | Tin oxide | 20 | S-2 | M-4 | 80 | 200 | 5 | 18 | B | B | A |
| | 14 | ** | 30 | S-3 | Styrene | 100 | 150 | 5 | 13 | B | B | A |
| | 15 | Alumina | 30 | S-2 | Styrene | 50 | 100 | 25 | 14 | A | B | B |
| | 16 | ** | 6 | S-1 | — | — | 150 | 3 | 10 | B | A | B |
| | 17 | Alumina | 100 | S-1 | — | — | 100 | 25 | 7 | A | B | B |
| Comp. | 18 | ** | 6 | Isobutyl | M-1 | 100 | 150 | 3 | 27 | C | C | B |
| | | | | trimethoxy | | | | | | | | |
| | | | | silane | | | | | | | | |
| | 19 | ** | 30 | Vinyl | M-1 | 100 | 150 | 3 | 41 | C | B | C |
| | | | | triethoxy | | | | | | | | |
| | | | | silane | | | | | | | | |
| | 20 | None | — | — | M-1 | 100 | 150 | 3 | 32 | C | C | C |

| | | | | | | | | | | |
|---|---|---|---|---|---|---|---|---|---|---|
| 21 | ** | 6 | S-1 | M-1 | 100 | UV radiation | 66 | C | C | C |
| | | | | | | (500 W, 1 minute) | | | | |

Curable compound: M-1: Exemplified compound No. 31, M-2: Exemplified compound No. 1, M-3: Exemplified compound No. 42, M-4: Exemplified compound No. 44, M-5; Exemplified compound No. 18, Comp.: Comparative example,
**: Titanium oxide

It is obvious from Table 1 that the photoreceptors 1 to 17 of the invention exhibit good performances in all performances, but photoreceptors 18 to 21 other than the invention exhibit problems in at least any performance.

What is claimed is:

1. An electrophotographic photoreceptor comprising a conductive support provided thereon, a light sensitive layer and a surface layer in this order, wherein the surface layer is formed by a curing reaction of a composition comprising metal oxide particles of which surface are treated by at least a compound having methacryloyl group; and a peak value Tac at 1610-1640 cm⁻¹ and a peak value Tcb at 1700-1800 cm⁻¹ in an infrared absorption spectra of the surface layer after curing satisfy the following Expression 1;
1.0≦(Tac/Tcb)×100≦20. Expression 1

2. The electrophotographic photoreceptor of claim 1, wherein (Tac/Tcb)×100 in Expression 1 further satisfy the following Expression 2;
1.0≦(Tac/Tcb)×100≦10. Expression 2

3. The electrophotographic photoreceptor of claim 1, wherein the metal oxide particle is either a titan oxide or aluminum oxide.

4. The electrophotographic photoreceptor of claim 1, wherein the composition further comprising a curable compound.

5. The electrophotographic photoreceptor of claim 4, wherein the curable compound has either an acryloyl group or a methacryloyl group.

6. The electrophotographic photoreceptor of claim 1, wherein the compound having the methacryloyl group is a silane compound represented by Formula (1): 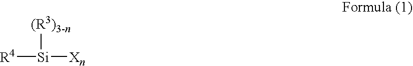
wherein R³ represents a hydrogen atom, an alkyl group having 1-10 carbon atoms and an aralkyl group having 1-10 carbon atoms, R⁴ represents an organic group having a reactive acryloyl group or methacryloyl group, X represents a halogen atom, an alcoxy group, an acyloxy group, an aminoxy group and a phenoxy group, and n represents an integer of 1-3.

7. An image forming apparatus comprising the electrophotographic photoreceptor of claim 1, a charging unit, an image exposing unit, a developing unit and a transfer unit.
